(19) United States
(12) Patent Application Publication
(10) Pub. No.: US 2011/0216129 A1
(43) Pub. Date: Sep. 8, 2011

(54) INKJET HEAD AND INKJET RECORDING DEVICE

(75) Inventors: Ryutaro Kusunoki, Shizuoka-ken (JP); Yasuhito Kiji, Shizuoka-ken (JP)

(73) Assignee: TOSHIBA TEC KABUSHIKI KAISHA, Tokyo (JP)

(21) Appl. No.: 13/037,552

(22) Filed: Mar. 1, 2011

(30) Foreign Application Priority Data
Mar. 2, 2010 (JP) 2010-45099

(51) Int. Cl. B41J 2/045

(52) U.S. Cl. 347/68

(57) ABSTRACT

According to one embodiment, an inkjet head includes: plural piezoelectric element partition walls, a nozzle plate, a frame member, and a sealing member. The piezoelectric element partition walls are arrayed on a substrate in a direction orthogonal to a predetermined ink ejecting direction and forms partition walls of plural pressure chambers. The nozzle plate is bonded to be crosslinked to top surfaces of the plural piezoelectric element partition walls and the plural nozzle holes are formed in the nozzle plate. The frame member surrounds the piezoelectric element partition walls. The sealing member is bonded to a surface of the nozzle plate on a side not opposed to the piezoelectric element partition walls and bonded to a top surface of the frame member and has openings in positions corresponding to the plural nozzle holes.

### CROSS-REFERENCE TO RELATED APPLICATION

This application is based upon and claims the benefit of priority from Japanese Application No. 2010-45099, filed on Mar. 2, 2010; the entire contents of which are incorporated herein by reference.

### FIELD

Embodiments described herein relate generally to a technique for an arrangement structure of a nozzle plate in an inkjet head.

### BACKGROUND

(A) In the past, an inkjet head is known in which a projection section including a piezoelectric element is formed on a substrate, plural pressure chambers and plural piezoelectric actuators are formed by forming plural grooves in the projection section, a frame member is joined to a plane section on the substrate, and a nozzle plate are bonded to the upper surface of the frame member and the top upper surface of the projection section.

In the inkjet head, a space formed by the substrate, the frame member, the projection section, and the nozzle plate is used as an ink supply path or an ink discharge path. In the inkjet head, it is possible to forcibly supply ink from the ink supply path to the pressure chambers and discharge the ink, which is not ejected from nozzles, from the pressure chambers to the ink discharge path. Therefore, it is possible to forcibly cause convection of the ink in the pressure chambers irrespective of presence or absence of the ejection of the ink from the nozzles. Since the ink can be forcibly discharged even if air bubbles or foreign matters are mixed in the pressure chambers because of the forcible convection, it is possible to minimize a failure in which the ink is not ejected because of the air bubbles or the foreign matters.

(B) A configuration is also known in which a nozzle plate made of single crystal silicon is adopted. A large number of nozzle holes are formed in the nozzle plate by dry etching. Since the nozzle plate is made of the single crystal silicon, it is possible to easily apply a semiconductor micromachining technique such as the dry etching and form highly-accurate nozzle holes. Since the nozzle holes are highly accurately processed, it is possible to improve arrival position accuracy of liquid droplets discharged from the nozzle holes. Therefore, it is possible to improve printing quality. Alternatively, when an inkjet head is applied to manufacturing of an electronic device such as a flat panel display, it is possible to improve yield of a manufacturing process.

It is assumed that the nozzle plate of (B) is applied to the inkjet head of (A). In this case, two problems explained below occur.

A first problem is that it is difficult to inexpensively provide the inkjet head. Since the nozzle plate of (A) has a function of sealing not only the pressure chambers but also the ink supply path, the nozzle plate needs to have a large area. On the other hand, since nozzles are formed by the semiconductor micromachining technique in the nozzle plate of (B), manufacturing cost for the nozzle plate is higher as the area of the nozzle plate is larger.

A second problem is that the nozzle plate tends to be damaged in a bonding process for the nozzle plate. In a process for manufacturing the inkjet head of (A), first, the substrate is cut to form the projection section and, subsequently, the plural grooves are formed in the projection section to form the plural pressure chambers and the plural piezoelectric actuators. Subsequently, the frame member is bonded to the substrate and, finally, the nozzle plate is bonded to the upper surfaces of the projection section and the frame member. However, since the nozzle plate made of the single crystal silicon of (B) is an extremely fragile material, if there is a difference between height positions of the top surface of the projection section and the upper surface of the frame member, in some case, the nozzle plate cracks because of stress generated therein when the nozzle plate is bonded. It is conceivable to simultaneously polish the top surface of the projection section and the upper surface of the frame member to prevent a difference in level from occurring. However, since the large number of columnar piezoelectric actuators are formed among the pressure chambers on the top surface of the projection section, it is likely that the piezoelectric actuators are broken during the polishing. It is difficult to form the grooves in the projection section after polishing the projection section and the frame member. This is because, since the diameter of a rotary knife that can be used for the cutting is large compared with a space between the projection section and the frame member, even the frame member is processed when the projection section is grooved.

### DESCRIPTION OF THE DRAWINGS

FIG. 1 is an external perspective view of an inkjet head;

FIG. 2 is a schematic plan view of the inkjet head;

FIG. 3 is a sectional view of the inkjet head taken along line A-A shown in FIG. 2;

FIG. 4 is a sectional view of the inkjet head taken along line B-B shown in FIG. 3;

FIG. 5 is a longitudinal sectional view of a nozzle taken along a z-x plane; and

FIG. 6 is a schematic diagram of an inkjet recording device including the inkjet head.

### DETAILED DESCRIPTION

In general, according to one embodiment, an inkjet head includes: a substrate; plural piezoelectric element partition walls arrayed on the substrate in a direction orthogonal to a predetermined ink ejecting direction and configured to form partition walls of plural pressure chambers respectively corresponding to plural nozzle holes; a nozzle plate extending in the direction of the array of the plural piezoelectric element partition walls and bonded to be crosslinked to top surfaces of the plural piezoelectric element partition walls, the plural nozzle holes being formed in the nozzle plate; a frame member arranged on the substrate and configured to surround the piezoelectric element partition walls; and a sealing member bonded to surfaces of the nozzle plate on a side not opposed to the piezoelectric element partition walls, bonded to a top surface of the frame member, and having openings in positions corresponding to the plural nozzle holes.

An embodiment is explained below with reference to the accompanying drawings.

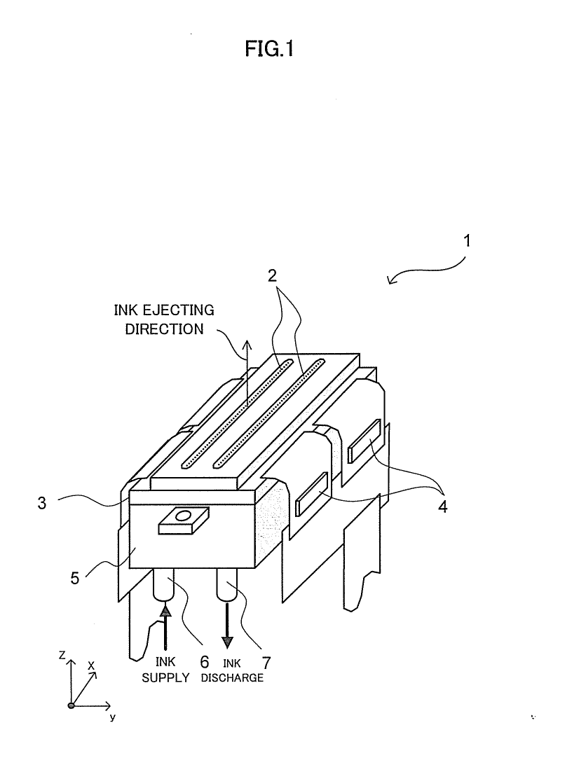

FIG. 1 is an external perspective view of an inkjet head 1.

The inkjet head 1 includes a head substrate 3 including nozzles 2 from which ink is ejected, driver ICs 4 configured to generate a driving signal, and a manifold 5 including an ink supply port 6 and an ink discharge port 7.

The inkjet head 1 ejects ink, which is supplied from the ink supply port 6, from the nozzles 2 according to the driving signal generated by the driver ICs 4. The ink not ejected from the nozzles 2 of the ink flown in from the ink supply port 6 is discharged from the ink discharge port 7.

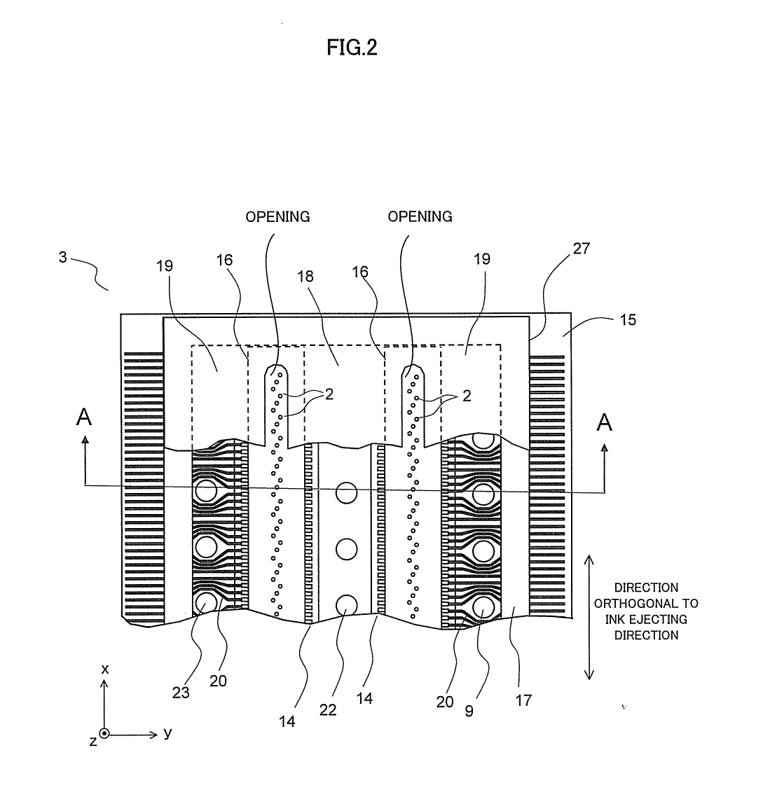

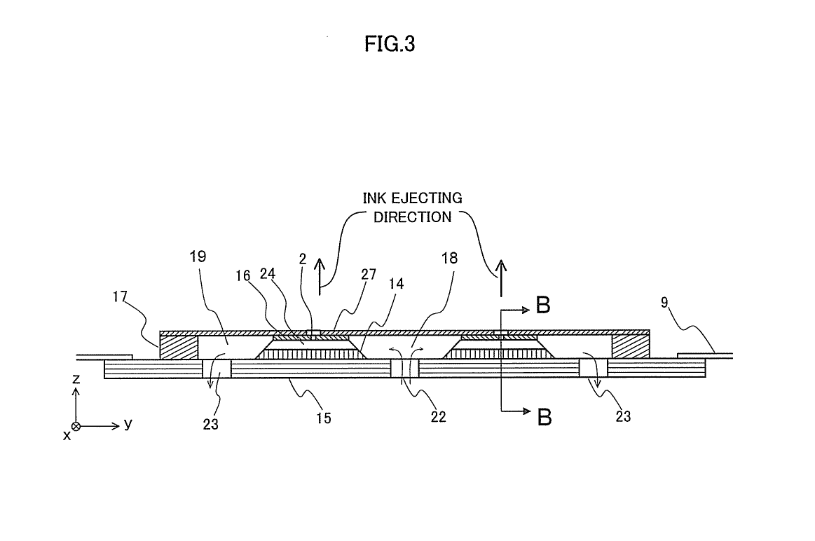

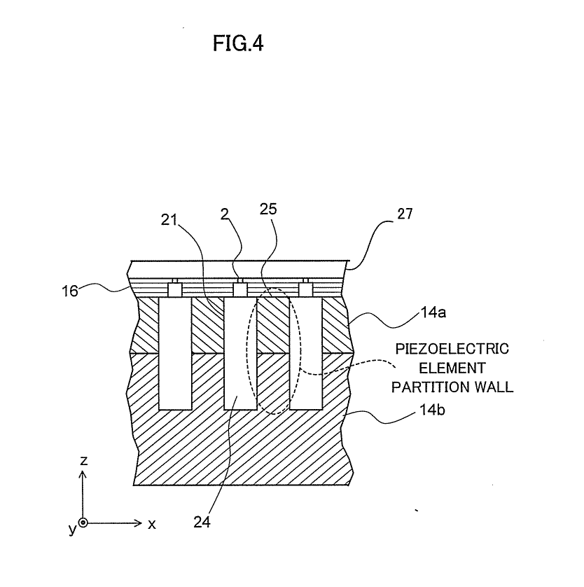

FIG. 2 is a schematic plan view of the inkjet head. FIG. 3 is a sectional view of the inkjet head taken along line A-A shown in FIG. 2. FIG. 4 is a sectional view of the inkjet head taken along line B-B shown in FIG. 3.

The head substrate 3 includes piezoelectric members 14, a base substrate 15 (a substrate), nozzle plates 16, a frame member 17, and a sealing member 27. A space in the center surrounded by the base substrate 15, the piezoelectric members 14, and the sealing member 27 forms an ink supply path 18 for supplying ink to pressure chambers 24. The frame member 17 is bonded on the base substrate 15 and surrounds the piezoelectric members 14 and the like.

Spaces surrounded by the base substrate 15, the piezoelectric members 14, the frame member 17, and the sealing member 27 form ink discharge paths 19 for discharging the ink from the pressure chambers 24.

On the base substrate 15, wiring electrodes 20 electrically connecting electrodes 21 (see FIG. 4) formed on inner walls of the pressure chambers 24 and the driver ICs 4 are formed. Further, in the base substrate 15, ink supply holes 22 communicating with the ink supply path 18 and ink discharge holes 23 communicating with the ink discharge paths 19 are formed. The ink supply holes 22 are hydraulically connected to the ink supply port 6 by the manifold 5 (see FIG. 1). The ink discharge holes 23 are hydraulically connected to the ink discharge port 7 by the manifold 5.

The base substrate 15 is desirably formed of a material having a small dielectric constant and a small difference in a coefficient of thermal expansion from that of the piezoelectric members 14. As the material of the base substrate 15, for example, alumina (Al₂O₃), silicon nitride (Si₃N₄), silicon carbide (SiC), aluminum nitride (AlN), lead zirconate titanate (PZT), or the like can be adopted. In this embodiment, as an example, PZT having a low dielectric constant is adopted.

The piezoelectric members 14 extending in the x axis direction are joined on the base substrate 15. Each of the piezoelectric members 14 is formed by laminating a piezoelectric member 14a and a piezoelectric member 14b polarized in directions opposite to each other along a plate thickness direction. In the piezoelectric member 14, plural long grooves connected from the ink supply path 18 to the ink discharge paths 19 are formed in parallel. The electrodes 21 are formed on inner surfaces of the long grooves (see FIG. 4). Spaces surrounded by the long grooves and one surfaces of the nozzle plates 16, which are provided on the piezoelectric member 14 and cover the long grooves, are the pressure chambers 24. In this way, the nozzle plates 16 extend in the direction in which the plural piezoelectric element partition walls are arrayed (see FIG. 2) and bonded to be crosslinked to the top surfaces of the plural piezoelectric element partition walls (see FIG. 4). Plural nozzle holes are formed in the nozzle plates 16 (see FIG. 2).

The nozzle plates 16 are bonded to cover the entire region of a rectangular top surface of each of the plural piezoelectric element partition walls. In this way, the nozzle plates 16 are bonded to be closely attached to a wide range of the top surface of each of the piezoelectric element partition walls. This makes it possible to firmly bond the nozzle plates 16 to the plural piezoelectric element partition walls.

Consequently, the plural piezoelectric element partition walls including piezoelectric elements are erected on the base substrate 15. The piezoelectric element partition walls are arrayed on the base substrate 15 in a direction orthogonal to a predetermined ink ejecting direction. The plural piezoelectric element partition walls form partition walls of plural pressure chambers respectively corresponding to the plural nozzle holes.

In this embodiment, the plural piezoelectric element partition walls are arrayed to form parallel plural rows (two rows). The nozzle plates 16 are arranged to be divided into two rows to correspond to the respective plural rows of the piezoelectric element partition walls.

The electrodes 21 are connected to the driver ICs 4 through the wiring electrodes 20. The piezoelectric members 14 among the pressure chambers 24 adjacent to one another are sandwiched by the electrodes 21 provided in the pressure chambers 24 to form actuators 25 (see FIG. 4).

If an electric field is applied to the actuators 25 by the driving signal generated by the driver ICs 4, the actuators 25 are sheared in the shape of the hiragana character “ku” to have vertexes in joining sections of the piezoelectric member 14a and the piezoelectric member 14b. According to the deformation of the actuators 25, the capacity of the pressure chambers 24 changes and the ink on the inside of the pressure chambers 24 is pressed. The ink pressed in the pressure chambers 24 is ejected from the nozzles 2.

Specifically, the piezoelectric members 14 can be formed of lead zirconate titanate (PZT: Pb(Zr,Ti)O₃), lithium niobate (LiNbO₃), lithium tantalate (LiTaO₃), or the like. In this embodiment, as an example, zirconate titanate (PZT) having a relatively high piezoelectric constant is adopted.

The electrodes 21 have a two-layer structure of nickel (Ni) and gold (Au). The electrodes 21 are uniformly formed in the long grooves formed in the piezoelectric members 14 (see FIG. 4). As a method of forming the electrodes 21, besides a plating method, a sputtering method, a vapor deposition method, or the like can also be adopted. The pressure chambers 24 are formed in a shape having depth of 300 μm and width of 80 μm and arrayed in parallel at a pitch of 169 μm.

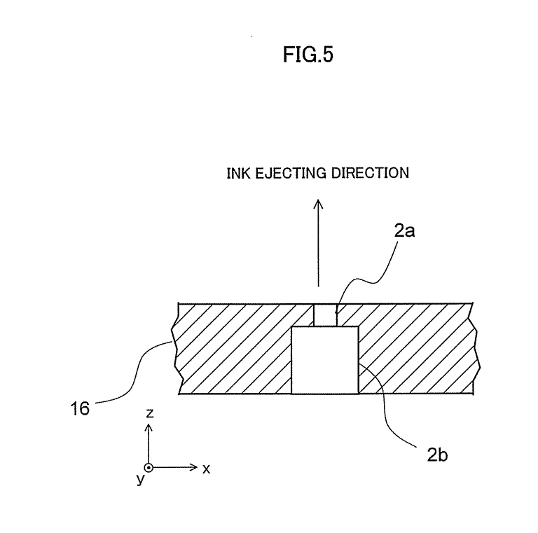

FIG. 5 is a longitudinal sectional view of the nozzle taken along a z-x plane. In the nozzle plates 16, the nozzle 2 is formed in a position offset at every three periods from the center in a longitudinal direction of the pressure chamber 24 (the y axis direction). The nozzle 2 has a small hole 2a on an ink ejection side and has a large hole 2b on the pressure chamber 24 side. The nozzle holes 2a and 2b can be formed at high accuracy by dry etching, wet etching, or the like. In this embodiment, as an example of a material of the nozzle plates 16, single crystal silicon is adopted.

As the material of the nozzle plates 16, nickel can also be adopted. The nozzle plates 16 can be formed by an electrocasting method. The size of the nozzle plates 16 is minimum size for covering openings of the pressure chambers 24 (e.g., width in the y axis direction is 2 mm, thickness in the z axis direction is 50 μm, and length in the x axis direction is 50 mm to 60 mm). By holding down the size of the nozzle plates 16, it is possible to increase the number of nozzle plates obtained from work performed once in a nozzle hole forming process by dry etching or wet etching. Therefore, it is possible to reduce manufacturing cost for the nozzle plates 16.

The sealing member 27 is bonded to surfaces of the nozzle plates 16 on a side not opposed to the piezoelectric element partition walls and the top surface of the frame member 17. The sealing member 27 seals the upper surfaces of the ink supply path 18 and the ink discharge paths 19. In the sealing member 27, openings are provided in positions corresponding to the nozzles 2 (plural nozzle holes).

The sealing member 27 is formed of a flexible material such as a polyimide film or a stainless steel plate. Therefore, even if a difference in level occurs between the surfaces of the nozzle plates 16 on the side not opposed to the pressure chambers 24 and the top surface of the frame member 17, the sealing member 27 can be bonded. Liquid repellent coating is applied to the sealing member 27.

A method of manufacturing the head substrate 3 is explained below.

First, the piezoelectric members 14 bonded in a state in which the piezoelectric members 14 are polarized in directions opposite to each other are bonded to the base substrate 15 in which the ink supply holes 22 and the ink discharge holes 23 are provided. Epoxy resin adhesive is used for the bonding of the piezoelectric members 14 to the base substrate 15. The epoxy resin adhesive is also used for bonding processing for members after the bonding of the piezoelectric members 14.

Subsequently, the piezoelectric members 14 and the base substrate 15 are cut by a rotary knife having a trapezoidal section to form projections of the piezoelectric members 14 in a trapezoidal shape on the base substrate 15. In this embodiment, the height of the piezoelectric members 14 in the z axis direction from the surface of the base substrate 15 is about 500 μm. Subsequently, masks of wiring electrodes are formed on the upper surface of the base substrate 15 by a method of photolithography. Subsequently, grooves are formed in the trapezoidal projections of the piezoelectric members 14 by a dicer to form the pressure chambers 24 and the actuators 25. Electroless nickel plating is applied to the base substrate 15 and the piezoelectric members 14.

Further, electrolytic gold plating is applied on the electroless nickel plating. The nozzle plates 16, in which a large number of the nozzles 2 are formed in advance, are bonded to the top surfaces of the projections of the piezoelectric members 14. The frame member 17 is bonded to the upper surface of the base substrate 15. The sealing member 27 is bonded to the top surface of the frame member 17 and the surfaces of the nozzle plates 16 on the side not opposed to the pressure chambers 24.

By adopting such a configuration, even if there is a difference in a height position in the z axis direction between the top surface of the frame member 17 and the surfaces of the nozzle plates 16 on the side not opposed to the pressure chambers 24, since the flexible sealing member 27 is deformed, it is possible to facilitate work for bonding the sealing member 27 to the frame member 17 and the nozzle plates 16.

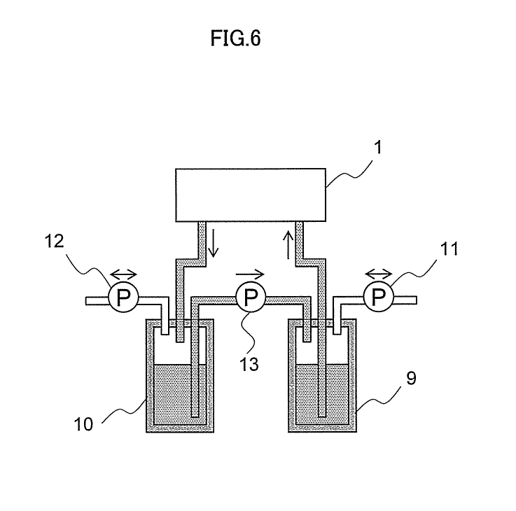

FIG. 6 is a schematic diagram of an inkjet recording device including the inkjet head.

As shown in the figure, in the inkjet recording device according to this embodiment, ink is supplied to the inkjet head 1 and the ink discharged from the inkjet head 1 is recirculated to the inkjet head 1 using an ink recirculating mechanism.

Specifically, the ink recirculating mechanism includes a supply-side ink tank 9, a discharge-side ink tank 10, a supply-side pressure adjustment pump 11, a transfer pump 12, a discharge-side pressure adjustment pump 13, and a tube that hydraulically connects the tanks and the pumps.

The supply-side pressure adjustment pump 11 and the discharge-side pressure adjustment pump 13 respectively adjust the pressure of the supply-side ink tank 9 and the pressure of the discharge-side ink tank 10. The supply-side ink tank 9 supplies the ink to the ink supply port 6 of the inkjet head 1. The discharge-side ink tank 10 temporarily stores the ink discharged from the ink discharge port 7 of the inkjet head 1. The transfer pump 12 recirculates the ink stored in the discharge-side ink tank 10 to the supply-side ink tank 9.

The inkjet recording device according to this embodiment shifts to a maintenance mode, for example, at the end of an image forming operation on a recording medium such as a sheet and executes, for example, a suction operation or a wiping operation as a part of a maintenance operation. During the wiping operation, the sealing member 27 is wiped by a blade made of an elastic member such as rubber.

The openings formed in the sealing member 27 are formed in a shape for not disturbing ejection of the ink from the nozzle holes 2 formed in the nozzle plates 16 and for preventing the elastic member, which is elastically deformed when the sealing member 27 is wiped by the elastic member, from coming into contact with the surfaces of the nozzle plates 16. Consequently, in the wiping operation, the blade made of the elastic member does not come into contact with the surfaces of the nozzle plates 16. The nozzle holes on the surfaces of the nozzle plates 16 can be protected from scratching, breakage, and the like.

With the inkjet head and the inkjet recording device including the inkjet head according to this embodiment, it is possible to hold down the area of the nozzle plates 16, in which micromachining of nozzles is necessary, to a necessary minimum area. Therefore, it is possible to minimize a failure in which the ink is not ejected because of air bubbles or foreign matters. Further, it is possible to inexpensively provide an inkjet recording device having high arriving position accuracy.

If the plural rows of the piezoelectric members 14 are arranged as in this embodiment, the nozzle plates 16 independent from one another are separately bonded to the respective piezoelectric members formed in the plural rows. Therefore, even if relative positions of the plural rows of the piezoelectric members 14 change because of the influence of some external force, thermal expansion, or the like, unnatural force is not applied to the nozzle plates 16. It is possible to prevent breakage of the nozzle plates 16.

Since the sealing member 27 is made of the flexible material, even if there is a difference in a height position in the z axis direction between the top surface of the frame member 17 and the surfaces of the nozzle plates 16 on the side not opposed to the piezoelectric element partition walls, the flexible sealing member 27 is not broken. Therefore, it is possible to minimize occurrence of a failure in which the ink is not ejected because of air bubbles or foreign matters. Further, it is possible to manufacture, at high yield, an inkjet recording device having high arrival position accuracy.

As explained above in detail, with the technique described in this specification, it is possible to provide a technique for an arrangement structure of nozzle plates in an inkjet head. In particular, it is possible to provide a technique that can realize improvement of arrival position accuracy of ejected liquid droplets from nozzle holes in the inkjet head, prevention of breakage of the nozzle plates, and a reduction in cost.

While certain embodiments have been described, these embodiments have been presented by way of example only, and are not intended to limit the scope of invention. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet head comprising:
a substrate;
plural piezoelectric element partition walls arrayed on the substrate in a direction orthogonal to a predetermined ink ejecting direction and configured to form partition walls of plural pressure chambers respectively corresponding to plural nozzle holes;
a nozzle plate extending in the direction of the array of the plural piezoelectric element partition walls and bonded to be crosslinked to top surfaces of the plural piezoelectric element partition walls, the plural nozzle holes being formed in the nozzle plate;
a frame member arranged on the substrate and configured to surround the piezoelectric element partition walls; and
a sealing member bonded to a surface of the nozzle plate on a side not opposed to the piezoelectric element partition walls, bonded to a top surface of the frame member, and having openings in positions corresponding to the plural nozzle holes.

2. The inkjet head according to claim 1, wherein
the plural piezoelectric element partition walls are arranged to form parallel plural rows, and
the nozzle plate is arranged to be divided to correspond to the respective plural rows.

3. The inkjet head according to claim 1, wherein
the sealing member is wiped by an elastic member during a maintenance mode in an inkjet recording device including the inkjet head, and
the openings formed in the sealing member is formed in a shape for not disturbing discharge of ink from the nozzle holes formed in the nozzle plate and for preventing the elastic member, which is elastically deformed when the sealing member is wiped by the elastic member, from coming into contact with the nozzle plate.

4. The inkjet head according to claim 1, wherein the nozzle plate is bonded to cover an entire region of a top surface of each of the plural piezoelectric element partition walls.

5. The inkjet head according to claim 1, wherein the sealing member is formed of a flexible member.

6. The inkjet head according to claim 1, wherein the nozzle plate is formed of one of single crystal silicon and nickel.

7. An inkjet recording device comprising:
an inkjet head including:
a substrate;
plural piezoelectric element partition walls arrayed on the substrate in a direction orthogonal to a predetermined ink ejecting direction and configured to form partition walls of plural pressure chambers respectively corresponding to plural nozzle holes;
a nozzle plate extending in the direction of the array of the plural piezoelectric element partition walls and bonded to be crosslinked to top surfaces of the plural piezoelectric element partition walls, the plural nozzle holes being formed in the nozzle plate;
a frame member arranged on the substrate and configured to surround the piezoelectric element partition walls; and
a sealing member bonded to a surface of the nozzle plate on a side not opposed to the piezoelectric element partition walls and bonded to a top surface of the frame member and having openings in positions corresponding to the plural nozzle holes; and
an ink recirculating mechanism configured to supply ink to the inkjet head and recirculate the ink, which is discharged from the inkjet head, to the inkjet head.
